(19) United States
(12) Patent Application Publication
(10) Pub. No.: US 2026/0185677 A1
(43) Pub. Date: Jul. 2, 2026

(54) DESICCANT HOLDING MEANS FOR VEHICLE LAMP, VEHICLE LAMP AND MOTOR VEHICLE

(71) Applicant: VALEO VISION, Bobigny (FR)

(72) Inventors: Yaofeng GUO, Foshan (CN); Thierry ROUSSELET, Bobigny (FR)

(73) Assignee: VALEO VISION, Bobigny (FR)

(21) Appl. No.: 19/131,416

(22) PCT Filed: Nov. 24, 2023
(86) PCT No.: PCT/EP2023/083079

§ 371 Date: May 20, 2025

(30) Foreign Application Priority Data
Nov. 25, 2022 (CN) 202223153881.X

(51) Int. Cl. F21S 45/10; F21S 45/30; F21S 45/50; F21V 17/16

(52) U.S. Cl. CPC F21S 45/10; F21S 45/30; F21S 45/50; F21V 17/164

(57) ABSTRACT

The present invention provides a desiccant holding means for a vehicle lamp. The desiccant holding means includes a cover and a main body for holding a desiccant. The main body is sunk into the vehicle lamp from a lamp housing to form a holding space for the desiccant, the cover closes an opening of the main body, and a position-fixing structure for the desiccant is formed on the main body. The present invention further relates to a vehicle lamp and a motor vehicle.

### TECHNICAL FIELD

The present invention relates to the field of motor vehicles, in particular to a desiccant holding means for a vehicle lamp, a vehicle lamp, and a motor vehicle.

### BACKGROUND OF THE INVENTION

At present, vehicle lamps and especially vehicle lamps used on motor vehicles generally comprise a light source, a reflecting means located in a closed lamp housing, and a lens. The purpose of the lamp housing is to prevent water vapor, dust and similar contaminants from entering the vehicle lamp and contaminating the light source. Generally, the light sources in headlamps and signaling lamps for example release a large amount of heat while emitting light. Temperature and pressure cycles in the lamp housing caused by intermittent use of the vehicle lamp result in moisture accumulation and condensation inside the lamp housing.

### SUMMARY OF THE INVENTION

In order to solve at least one aspect of the above-mentioned problems and defects in the prior art, the present invention provides a desiccant holding means for a vehicle lamp, a vehicle lamp, and a motor vehicle using the vehicle lamp.

The present invention provides a desiccant holding means for a vehicle lamp, the desiccant holding means comprising a cover and a main body for holding a desiccant; the main body is sunk into the vehicle lamp from a lamp housing to form a holding space for the desiccant, the cover closes an opening of the main body, and a position-fixing structure for the desiccant is formed on the main body.

According to a non-limiting embodiment of the present invention, the main body is formed of a side wall and a bottom face, wherein a ventilation structure is formed on the bottom face and/or the side wall.

According to a non-limiting embodiment of the present invention, at least one first rib extending towards an interior space of the main body is formed on the side wall, the desiccant being clamped between the at least one first rib, and/or
at least one second rib extending towards an interior space of the main body is formed on the bottom face, the desiccant being clamped between the at least one second rib and the cover.

According to a non-limiting embodiment of the present invention, at least one elastic rib extending towards an interior space of the main body is formed on the side wall and/or the bottom face, the at least one elastic rib being configured to retain the desiccant.

According to a non-limiting embodiment of the present invention, the cover is detachably fixed to the lamp housing.

According to a non-limiting embodiment of the present invention, a fixing structure for fixing the cover is formed on the lamp housing at an outer side of the opening.

According to a non-limiting embodiment of the present invention, the cover is connected to the fixing structure by means of a threaded connection, a snap-fit connection or a self-sealing structure.

According to a non-limiting embodiment of the present invention, a sealing washer is provided between the cover and the fixing structure.

According to a non-limiting embodiment of the present invention, a protrusion is provided on an inner side of the cover.

According to a non-limiting embodiment of the present invention, the side wall and bottom face are part of the lamp housing.

According to a non-limiting embodiment of the present invention, the main body is formed independently of the lamp housing, and fixed to the lamp housing.

According to a non-limiting embodiment of the present invention, the main body is snap-fitted to the lamp housing; a snap tongue and a snap slot are formed on the side wall of the main body, and a ridge is formed on the lamp housing, the ridge being configured to be engaged in the snap slot and limited by the snap tongue.

The present invention also provides a vehicle lamp having the desiccant holding means described above.

The present invention also provides a motor vehicle comprising the abovementioned vehicle lamp.

The embodiments of the present invention has the following advantages: there is no need for an additional desiccant holding means, process steps and starting materials are reduced, costs are lowered; the cover is easy to remove, such that when the desiccant material fails or needs to be replaced, the operation of replacing the desiccant can be performed simply and conveniently.

### BRIEF DESCRIPTION OF THE DRAWINGS

These and/or other aspects and advantages of the present invention will become obvious and easy to understand through the following description of preferred embodiments which makes reference to the accompanying drawings, wherein:

FIG. 1 is a front view of a desiccant holding means for a vehicle lamp of a motor vehicle according to an embodiment of the present invention, without a cover.

FIG. 2 is a cross-sectional drawing of a desiccant holding means for a vehicle lamp of a motor vehicle according to an embodiment of the present invention, with a cover.

FIG. 3 is a schematic drawing of a desiccant holding means for a vehicle lamp of a motor vehicle according to an embodiment of the present invention when it is holding desiccant.

FIG. 4, FIG. 5 and FIG. 6 are structural schematic drawings of a desiccant holding means for a vehicle lamp of a motor vehicle according to another embodiment of the present invention.

FIG. 7 is a structural schematic sectional drawing of a desiccant holding means for a vehicle lamp of a motor vehicle according to an embodiment of the present invention.

FIG. 8 is an enlarged schematic drawing of a partial region A in FIG. 7.

FIG. 9 is a structural schematic sectional drawing of a desiccant holding means for a vehicle lamp of a motor vehicle according to another embodiment of the present invention.

FIG. 10 is a structural schematic sectional drawing of a desiccant holding means for a vehicle lamp of a motor vehicle according to another embodiment of the present invention.

### DETAILED DESCRIPTION OF THE INVENTION

The technical solution of the present invention is described in further detail below by means of embodiments with reference to the drawings. Herein, identical or similar reference labels indicate identical or similar components. The following description of embodiments of the present invention with reference to the drawings is intended to explain the general inventive concept of the present invention, and should not be construed as a limitation on the present invention.

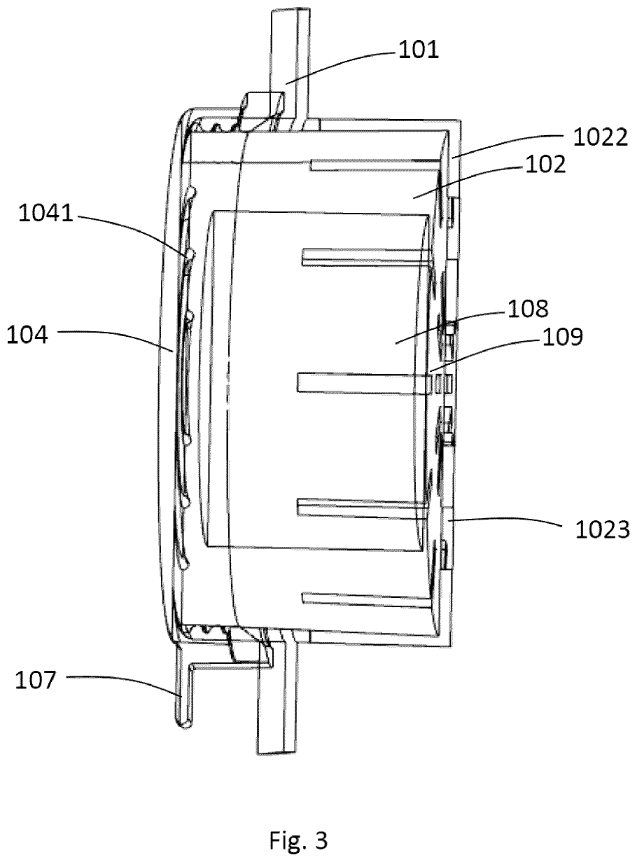

Referring to FIGS. 1-3, FIGS. 1-2 show views of a desiccant holding means for a vehicle lamp of a motor vehicle according to embodiments of the present invention, while FIG. 3 shows a schematic drawing of a desiccant holding means for a vehicle lamp of a motor vehicle according to an embodiment of the present invention when it is holding desiccant.

Specifically, as shown in FIGS. 1-3, the desiccant holding means 100 comprises a cover 104 and a main body 102 for holding a desiccant 108. The main body 102 is sunk into the vehicle lamp from the lamp housing to form a holding space for desiccant, and the cover 104 closes an opening 103 of the main body 102.

It will be understood that desiccant material is designed to solve the problem of moisture condensation and accumulation inside the vehicle lamp; having the desiccant holding means arranged on a lamp housing 101 is advantageous, because many components such as a light source, reflecting means and lens device are contained in the lamp housing 20, and the internal space is very cramped. By adopting the concept of the present utility model, such that the desiccant holding means for holding desiccant material is arranged on the lamp housing, effectiveness is ensured without taking up space inside the vehicle lamp. Furthermore, having the desiccant holding means arranged on the lamp housing facilitates replacement.

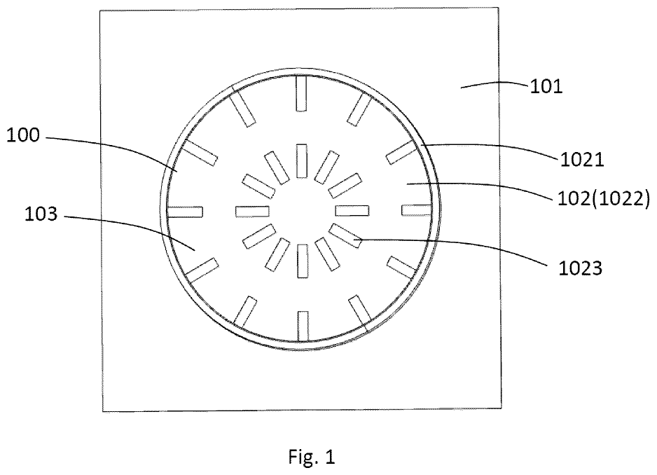

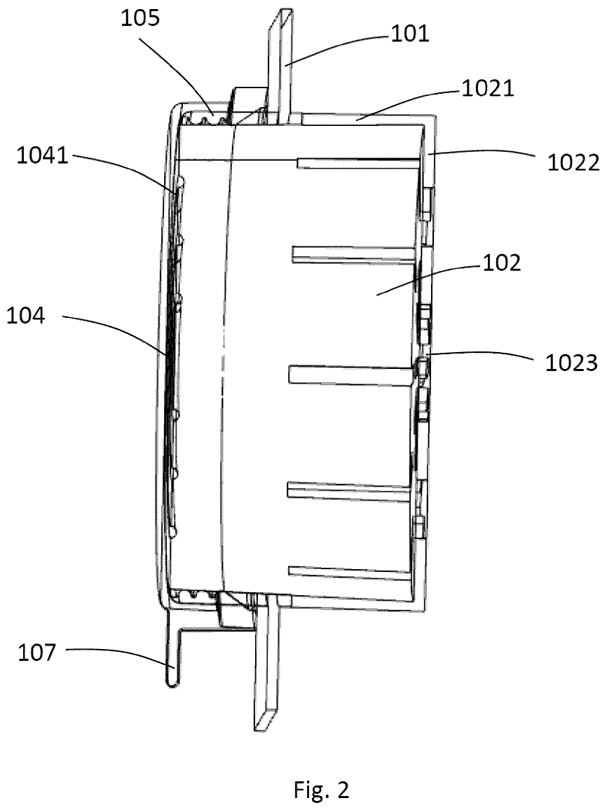

In an example, the main body 102 is delimited by a side wall 1021 and a bottom face 1022. The main body 102 may have different shapes as required. In the example shown in FIGS. 1-2, the main body 102 has a cylindrical shape, but in other examples, the main body 102 may also have the shape of a sphere, ellipsoid, cuboid or cube, etc. Of course, the main body 102 is not limited to the specific shapes mentioned above, and those skilled in the art may design shapes corresponding to requirements.

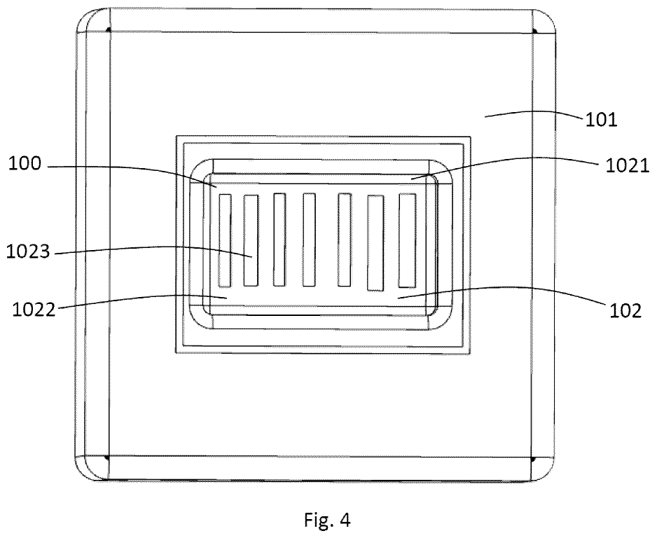

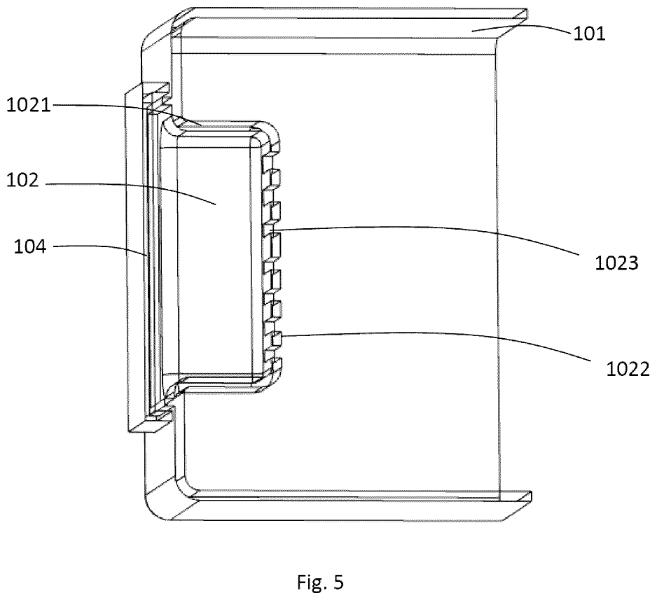

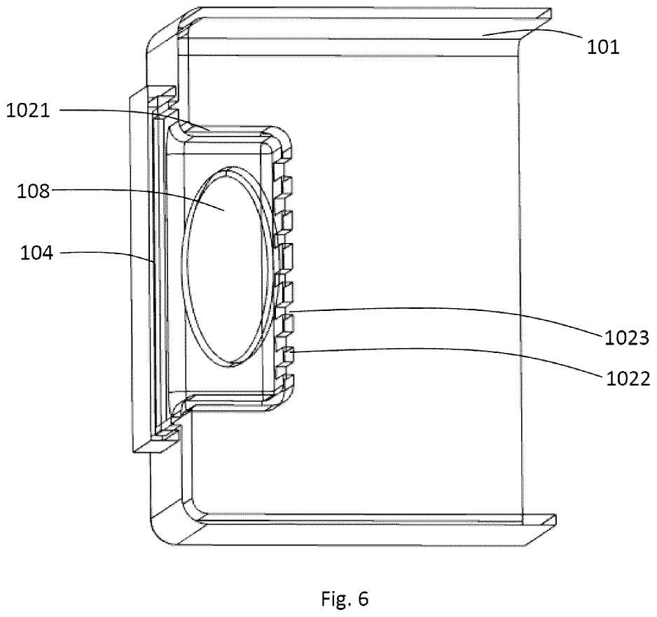

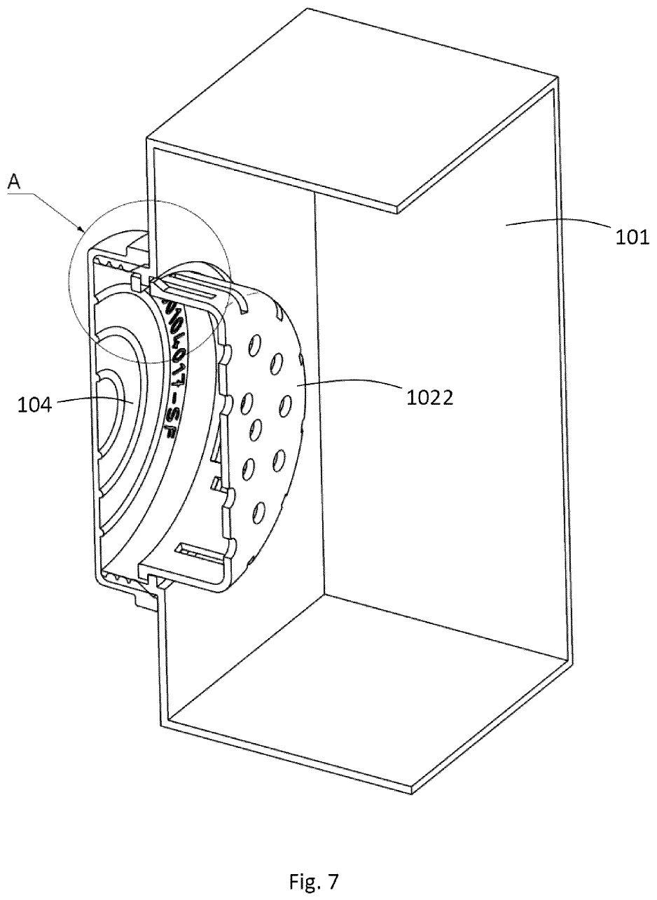

In an example, a ventilation structure 1023 is formed on the bottom face 1022, for connecting the main body 102 to the interior of the vehicle lamp, to make it easier for the desiccant to take effect. The ventilation structure 1023 may be configured as a ventilation slot 1024 as shown in-FIG. 1, FIG. 2, FIG. 3, FIG. 4, FIG. 5, and FIG. 6. There are preferably multiple ventilation slots 1024. In the examples shown in FIGS. 1-6, the ventilation slot 1024 is a linear ventilation slot. However, in other examples, the ventilation slot 1024 may be configured to have other shapes, or arranged in a specific pattern. In another example, as shown in FIG. 7, the ventilation structure may be configured as a ventilation hole. Of course, the ventilation slot or ventilation hole is not limited to the specific shapes mentioned above, and those skilled in the art may design shapes corresponding to requirements.

In an example, a ventilation structure may also be formed on the side wall 1021, to provide a better drying effect.

In an example, the side wall 1021 and bottom face 1022 of the main body 102 are part of the lamp housing 101. That is, the main body 102 is an inward-sunk space on the lamp housing 101, and integrally formed with the lamp housing 101. Such a configuration can reduce the number of processing steps required to make the desiccant holding means, reduce the use of materials and save costs. According to the design of the present invention, the desiccant holding means 100 can also reduce the amount of space taken up on the lamp housing compared with a conventional design.

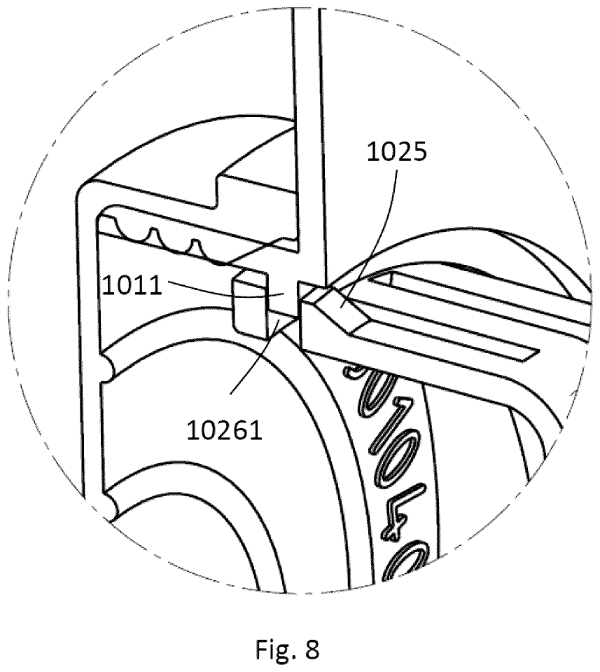

In another example, the main body 102 is formed independently of the lamp housing 101, and fixed to the lamp housing 101. As a non-limiting example, as shown in FIGS. 7 and 8, the main body 102 may be snap-fitted to the lamp housing 101. Specifically, a snap tongue 1025 and a snap slot 10261 are formed on the side wall 1021 of the main body 102, and a ridge 1011 is formed on the lamp housing 101. When the main body 102 is fitted to the lamp housing 101 in a direction towards the interior of the vehicle lamp, the snap tongue 1025 deforms elastically under the interfering action of the ridge 1011; when the ridge 1011 reaches the snap slot 10261, the elastic deformation of the snap tongue 1025 is reset and the snap tongue abuts a lower edge of the ridge 1011, thereby limiting the ridge 1011 in the snap slot 10261. As another non-limiting example, the main body 102 is fixed to the lamp housing 101 by connection with the aid of a bolt or screw.

In an example, the cover 104 seals the opening 103 of the main body 102, so as to retain the desiccant 108 held in the desiccant holding means, and isolate the desiccant from a space outside the vehicle lamp. The cover 104 is detachably fixed to the lamp housing 101.

When the desiccant 108 in the desiccant holding means 100 fails or needs to be replaced, the cover 104 can be detached and the desiccant holding means 100 can be opened to replace the desiccant 108 therein. Compared with a known desiccant holding means, the desiccant holding means 100 of the present invention has simpler and more convenient operation.

The cover 104 may be made of a material such as rubber, plastic or metal; the present invention imposes no specific restrictions in this respect.

The cover 104 may be fixed to the lamp housing 101 by means of a threaded connection, a snap-fit connection, or a self-sealing structure, etc. In an example, a fixing structure 105 for fixing the cover 104 is formed on the lamp housing 101 at an outer side of the opening 103. The cover 104 is preferably fixed to the lamp housing 101 by means of the fixing structure 105. For instance, in an example, the cover 104 is directly snap-fitted to the fixing structure 105. Or for instance, in another example, an internal thread is provided on an inner side of the cover 104, an external thread is provided on an outer side of the fixing structure 105, and the cover 104 and fixing structure 105 are fixed by threaded connection. In another example, an inner side of the cover 104 has elastic sealing ribs, and the cover 104 and fixing structure 105 are fixed by means of the elastic sealing ribs of the cover 104. Regarding the specific manner of connection between the cover 104 and the fixing structure 105, those skilled in the art may select another suitable manner of connection according to actual needs; the present invention imposes no restrictions in this respect.

In other examples, the cover 104 may be detachably fixed to the lamp housing 101 directly by means of a screw. The cover may be fixed to the lamp housing 101 in other ways; the present invention does not impose excessive restrictions on the manner of fixing of the cover 104.

To ensure that the vehicle lamp is closed, in order to prevent dust and water vapor, etc. from entering it, in an example, a sealing washer (not shown) is also provided between the cover 104 and the fixing structure 105. It will be understood that those skilled in the art may select a sealing washer or another form of sealing enhancement according to actual needs.

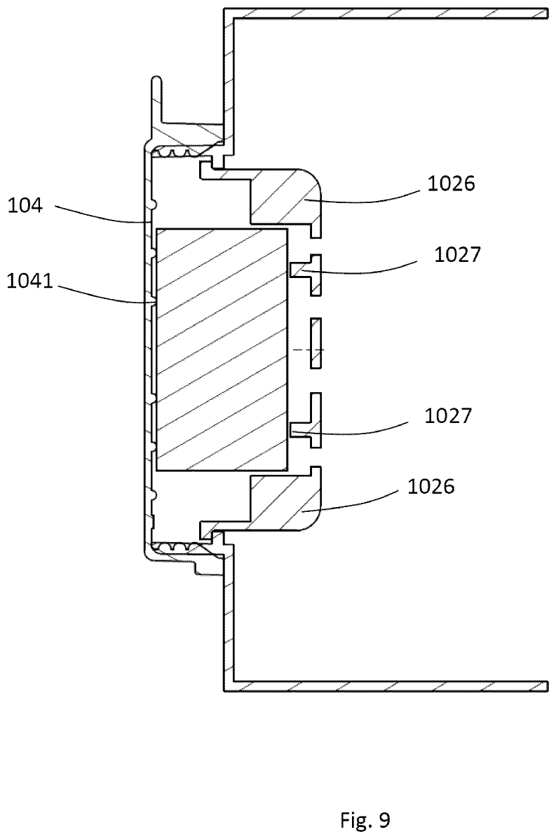

In an example, as shown in FIG. 9, a position-fixing structure for the desiccant 108 is formed on the side wall 1021 and/or bottom face 1022 of the main body 102, such that the desiccant 108 is at least partly fixed inside the main body 102. Specifically, as shown in FIG. 7, in an example, at least one first rib 1026 extending towards an interior space of the main body 102 is formed on the side wall 1021 of the main body 102, and the desiccant is clamped between the at least one first rib 1026, so as to fix the position of the desiccant in a direction transverse to the direction in which the main body 102 is sunk inwards; and/or at least one second rib 1027 extending towards the opening 103 of the main body 102 is formed on the bottom face 1022, and the desiccant 108 is clamped between the at least one second rib 1027 and the cover 104, so as to fix the position of the desiccant in the direction in which the main body 102 is sunk inwards. More preferably, a protrusion 1041 is provided on an inner side of the cover 104, the protrusion 1041 being able to cooperate with the second rib 1027 to clamp the desiccant 108, ensuring the stability of the desiccant 108 in the desiccant holding means 100. The desiccant 108 can be fixed without using other bonding methods.

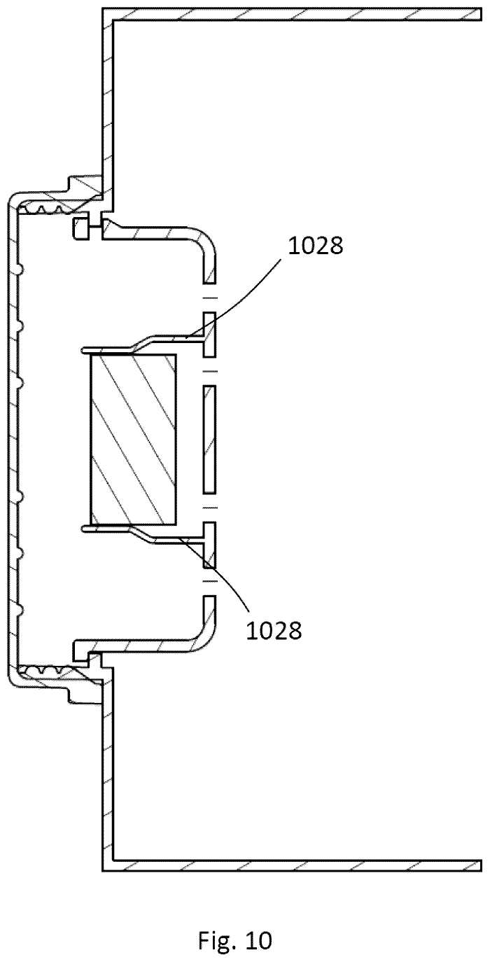

In another example, at least one elastic rib 1028 extending towards the interior space of the main body 102 is formed on the side wall 1021 and/or bottom face 1022 of the main body 102. When the desiccant 108 is installed, the elastic rib 1028 may be elastically deformed, and the elastic force thus generated clamps the desiccant 108 between the elastic ribs, as shown in FIG. 10. Alternatively, when the desiccant 108 is installed, the elastic rib 1028 may be elastically deformed, such that the desiccant 108 can be put into the bottom of the main body 102, and once the elastic rib 1028 has returned to its original position, the elastic rib can prevent the desiccant 108 from coming out, thus fixing the position of the desiccant 108. In contrast to the use of an adhesive to fix the desiccant, damage to or contamination of the desiccant by adhesive when replacing the desiccant can be prevented.

To ensure the stability of the desiccant 108 in the desiccant holding means 100, the desiccant 108 may also be bonded to the bottom face 1022 by means of an adhesive 109, etc.

In an example, a press-plate cooperating with the side wall 1021 may also be provided in the main body 102 holding the desiccant 108, in order to fix the desiccant 108.

In an example, to facilitate installation and removal of the cover 104, the cover 104 may also comprise a handle 107. The position and shape of the handle 107 may be selected according to actual needs; the present invention imposes no restrictions in this respect.

FIGS. 4-6 are structural schematic drawings of a desiccant holding means for a vehicle lamp according to another embodiment of the present invention. The example shown in FIGS. 4-6 and the example shown in FIGS. 1-3 differ only in the shape of the main body 102 and the position of the ventilation structure 1023. In this example, the main body 102 has a cuboid shape, and the ventilation structure 1023 is a ventilation slot disposed on the bottom face 1022. All of the above examples are exemplary illustrations of embodiments of the present invention, and do not limit the present invention.

The present invention also provides a vehicle lamp, having the desiccant holding means 100 described above.

In addition, the present invention also provides a motor vehicle. The motor vehicle comprises the abovementioned vehicle lamp.

It can be seen from the above that the desiccant holding means for a vehicle lamp, the vehicle lamp and the motor vehicle provided in the embodiments of the present disclosure have at least one of the following advantages: there is no need for an additional desiccant holding means, process steps and starting materials are reduced, costs are lowered; the cover is easy to remove, such that when the desiccant material fails or needs to be replaced, the operation of replacing the desiccant can be performed simply and conveniently.

It must be explained that the vehicle lamp mentioned in this embodiment may be an illuminating lamp and/or signaling lamp for a motor vehicle, e.g. a headlamp, a central high-position brake lamp, a turn signal lamp, a position lamp, a tail brake lamp, etc.

Although the present invention has been explained with reference to the drawings, the embodiments disclosed in the drawings are intended to provide an exemplary explanation of preferred embodiments of the present invention, and must not be interpreted as a limitation of the present invention. The dimensional proportions in the drawings are merely schematic, and must not be interpreted as a limitation of the present invention.

Although some embodiments of the general concept of the present invention have been disclosed and explained, those skilled in the art will understand that changes may be made to these embodiments without deviating from the principle and spirit of the general inventive concept, and the scope of the present invention is defined by the claims and their equivalents

What is claimed is:

1. A desiccant holder for a vehicle lamp, the desiccant holder comprising a cover and a main body for holding a desiccant, wherein the main body is sunk into the vehicle lamp from a lamp housing to form a holding space for the desiccant, the cover closes an opening of the main body, and a position-fixing structure for the desiccant is formed on the main body.

2. The desiccant holder for a vehicle lamp according to claim 1, wherein the main body includes a side wall and a bottom face, wherein a ventilation structure is formed on the bottom face and/or the side wall.

3. The desiccant holder for a vehicle lamp according to claim 2, wherein at least one first rib extending towards an interior space of the main body is formed on the side wall, the desiccant being clamped between the at least one first rib, and/or
at least one second rib extending towards an interior space of the main body is formed on the bottom face, the desiccant being clamped between the at least one second rib and the cover.

4. The desiccant holder for a vehicle lamp according to claim 2, wherein at least one elastic rib extending towards an interior space of the main body is formed on the side wall and/or the bottom face, the at least one elastic rib being configured to retain the desiccant.

5. The desiccant holder for a vehicle lamp according to claim 1, wherein the cover is detachably fixed to the lamp housing.

6. The desiccant holder for a vehicle lamp according to claim 5, wherein a fixing structure for fixing the cover is formed on the lamp housing at an outer side of the opening.

7. The desiccant holder for a vehicle lamp according to claim 6, wherein the cover is connected to the fixing structure by means of a threaded connection, a snap-fit connection or a self-sealing structure.

8. The desiccant holder for a vehicle lamp according to claim 7, wherein a sealing washer is provided between the cover and the fixing structure.

9. The desiccant holder for a vehicle lamp according to claim 1, wherein a protrusion is provided on an inner side of the cover.

10. The desiccant holder for a vehicle lamp according to claim 2, wherein the side wall and bottom face of the main body are part of the lamp housing.

11. The desiccant holder for a vehicle lamp according to claim 2, wherein the main body and the lamp housing are different components, and the main body is fixed to the lamp housing.

12. The desiccant holder for a vehicle lamp according to claim 11, wherein the main body is snap-fitted to the lamp housing; a snap tongue and a snap slot are formed on the side wall of the main body, and a ridge is formed on the lamp housing, the ridge being configured to be engaged in the snap slot and limited by the snap tongue.

13. A vehicle lamp, comprising a desiccant holder, the desiccant holder includes a cover and a main body for holding a desiccant, wherein the main body is sunk into the vehicle lamp from a lamp housing to form a holding space for the desiccant, the cover closes an opening of the main body, and a position-fixing structure for the desiccant is formed on the main body.

14. A motor vehicle, comprising a vehicle lamp, with the vehicle lamp including a desiccant holder, the desiccant holder includes a cover and a main body for holding a desiccant, wherein the main body is sunk into the vehicle lamp from a lamp housing to form a holding space for the desiccant, the cover closes an opening of the main body, and a position-fixing structure for the desiccant is formed on the main body.
